(19) United States
(12) Patent Application Publication
(10) Pub. No.: US 2026/0114364 A1
(43) Pub. Date: Apr. 30, 2026

(54) METHOD FOR CONTROLLING ELECTRIC UTILITY VEHICLE, ELECTRIC UTILITY VEHICLE, AND SYSTEM FOR CONTROLLING ELECTRIC UTILITY VEHICLE

(71) Applicant: JIANGSU DONGCHENG M&E TOOLS CO., LTD., Nantong (CN)

(72) Inventors: Haodong WANG, Nantong (CN); Yingfei FAN, Nantong (CN)

(21) Appl. No.: 19/433,118

(22) Filed: Dec. 26, 2025

Related U.S. Application Data
(63) Continuation of application No. PCT/CN2024/105448, filed on Jul. 15, 2024.

(30) Foreign Application Priority Data
Jul. 17, 2023 (CN) 202310874855.6

(51) Int. Cl. A01D 34/00; A01D 34/64; A01D 34/78; B60L 50/60; H04W 76/10

(52) U.S. Cl. CPC A01D 34/008; A01D 34/64; A01D 34/78; B60L 50/60; H04W 76/10; B60L 2200/40; B60L 2250/16; B60L 2250/30

(57) ABSTRACT

This application discloses a method for controlling an electric utility vehicle and an electric utility vehicle. The method includes: detecting a work load by the electric utility vehicle and establishing a communication connection between the electric utility vehicle and a mobile electronic device; the mobile electronic device receiving load information, prompting a user to change a work gear, or automatically matching an appropriate gear based on the load information in an automatic mode; the electric utility vehicle receiving a gear adjustment operation command sent by the mobile electronic device to adjust the work motor; and upon determining that the user has adjusted the gear of the electric utility vehicle by means of an operation assembly on the electric utility vehicle, an information transmission unit synchronizing the adjusted gear information to the mobile electronic device and providing feedback to the user.

### CROSS-REFERENCE TO RELATED APPLICATIONS

This application is a continuation of International Patent Application No. PCT/CN2024/105448, filed on Jul. 15, 2024, which claims priority to Chinese Patent Application No. 202310874855.6, filed on Jul. 17, 2023. The disclosures of the aforementioned applications are hereby incorporated by reference in their entireties.

### FIELD

The present application relates to a gear control method for an electric utility vehicle, an electric utility vehicle, and a system for controlling an electric utility vehicle.

### BACKGROUND

Ride-on lawn mowers, as a type of landscaping machinery, are widely used in the maintenance and arrangement of green spaces such as urban greenery and home gardens. Existing ride-on lawn mowers lack effective means when users need to remotely control the mowing gear, making it difficult to adjust the gear of the lawn mower remotely in an accurate, real-time, and intelligent manner, and the lawn mower also cannot adjust the gear automatically. As a result, during on-site operation and driving of the lawn mower, users often need to brake or pause the lawn mower before adjusting the gear, which is cumbersome and inconvenient. Even worse, distraction may occur if users operate the gear adjustment buttons or levers while operating and driving the lawn mower, thereby posing considerable risks.

In view of this, it is indeed necessary to provide an improved remote gear control method, a lawn mower, and a computer-readable medium to overcome the defects in the related art.

### SUMMARY

To address the drawbacks of the related art, the present application is directed to provide a remote gear control method applied to an electric utility vehicle, where the electric utility vehicle is particularly an electric lawn mower. The method includes the following steps: establishing a communication connection between the lawn mower and a mobile electronic device; determining whether an operational command for a last adjustment of the work gear of the lawn mower is received from the lawn mower or the mobile electronic device; in response to a determination that the operational command is received from the lawn mower, sending, by the lawn mower, first information including the adjusted work gear to the mobile electronic device, and recording and outputting externally, by the mobile electronic device, the first information; and in response to a determination that the operational command is received from the mobile electronic device, sending, by the mobile electronic device, second information including the operational command to the lawn mower, and adjusting, by the lawn mower, the work gear according to the received second information.

In some embodiments, the lawn mower is configured to, in a case that the communication connection is established between the lawn mower and the mobile electronic device, send third information to the mobile electronic device for user confirmation, where the third information includes a determination as to whether the work gear is to be adjusted as well as the adjusted work gear.

In some embodiments, the method includes: in response to a determination that the operational command is received from the mobile electronic device, sending, by the lawn mower, the third information to the mobile electronic device based on the real-time load.

In some embodiments, the work gear includes a plurality of fixed gears in one-to-one correspondence to different rotational speed values; the lawn mower includes a cutting element, and the lawn mower is configured to operate in one of the plurality of fixed gears, to adjust the rotational speed of the cutting element to a rotational speed value corresponding to the respective gear of the plurality of fixed gears; the work gear further includes an automatic gear corresponding to a variable rotational speed value, and the lawn mower is configured to operate in the automatic gear to adjust the rotational speed of the cutting element based on the real-time load of the lawn mower.

In some embodiments, the method further includes: during the operation of the lawn mower, collecting operational parameters of a power source that drives the cutting element; based on the operational parameters, identifying the real-time load of the lawn mower. The operational parameters include one or more parameters selected from a group including a rotational speed, PWM duty cycle, voltage, current, and freewheeling time.

In some embodiments, the mobile electronic device includes a mobile phone, wherein recording and outputting externally, by the mobile electronic device, the first information specifically includes: storing the first information by the mobile phone, displaying the first information on a display screen of the mobile phone, and/or playing the first information through a speaker or earphones of the mobile phone.

In some embodiments, in the case that the communication connection is established between the lawn mower and the mobile electronic device, the method further includes: sending, by the mobile electronic device, a request for acquiring a device ID to the lawn mower; upon receiving the request, sending, by the lawn mower, the device ID to the mobile electronic device; connecting the mobile electronic device to the Internet and searching a cloud server for a determination of whether the device ID has usage permission; wherein in response to a determination that the mobile electronic device has the usage permission, enabling the lawn mower to execute the operational command received from the mobile electronic device, and uploading, by the mobile electronic device, the first information and the second information to the cloud server; and in response to a determination that the mobile electronic device does not have the usage permission, prohibiting the lawn mower from executing the operational command received from the mobile electronic device.

To solve the problems in the related art, the present application further provides an electric lawn mower, including: a communication module, configured to establish a communication connection between the lawn mower and a mobile electronic device; a control module, configured to determine whether an operational command for a last adjustment of the work gear of the lawn mower is received from the lawn mower or the mobile electronic device; wherein the lawn mower is configured to, in response to a determination that the operational command is received from the lawn mower, send first information including the adjusted work gear to the mobile electronic device, and the mobile electronic device is configured to record and output externally the first information. The mobile electronic device is configured to, in response to a determination that the operational command is received from the mobile electronic device, send second information including the operational command to the lawn mower, and the lawn mower is configured to adjust the work gear according to the received second information.

To solve the problems in the related art, the present application further provides an electric lawn mower, including a memory and a processor; the memory stores computer instructions; the processor is connected to the memory and configured to obtain and execute the computer instructions in the memory to implement the aforementioned method.

To solve the problems in the related art, the present application further provides a computer-readable medium including a non-volatile program code executable by a processor, where the program code is executed by the processor to implement the aforementioned method.

Compared with the related art, the present application has the following beneficial effects. The remote gear control method of the present application enables users to remotely control the lawn mower by establishing a communication connection between the lawn mower and the mobile electronic device; the mobile electronic device can update, record, and output the gear status of the lawn mower in real time, achieving the effects of remote monitoring and intelligent management. The lawn mower can adjust the gear automatically, which not only can adjust the output of the mowing blade according to the grass condition to improve the overall battery life of the lawn mower, but also enables users to eliminate the need for the manual gear adjustment operation, which is very safe and convenient.

### BRIEF DESCRIPTION OF THE DRAWINGS

The specific implementations of the present application will be described in further detail below with reference to the accompanying drawings:

FIG. 1 is a flowchart of a remote gear control method according to Embodiment 1 of the present application;

FIG. 2 is a schematic structural diagram of a lawn mower according to Embodiment 2 of the present application;

FIG. 3 is a schematic structural diagram of a vehicle system according to Embodiment of the present application;

FIG. 4 is another schematic structural diagram of the vehicle system according to Embodiment 5 of the present application;

FIG. 5 is a flowchart of regulating the lawn mower according to the load in Embodiment 5 of the present application;

FIG. 6 is a flowchart of writing a machine ID into the lawn mower in Embodiment 5 of the present application;

FIG. 7 is a block diagram of the circuit principle of a controller in Embodiment 5 of the present application;

FIG. 8 is a flowchart of the interconnection software operation between the lawn mower and a mobile phone App in Embodiment 5 of the present application.

### DETAILED DESCRIPTION

The present application will be further described in detail below with reference to the accompanying drawings and implementations.

The terms used in the present application are only for the purpose of describing specific embodiments and are not intended to limit the present application. For example, the terms “first”, “second”, “third” and the like mentioned below are only for the convenience of distinguishing and describing the relevant parameters involved in the present application, and have no special meanings, so they should not be understood as limiting the present application.

### Embodiment 1

In order to address the shortcomings of the related art, the present application is directed to provide a gear control method for an electric utility vehicle. The electric utility vehicle is a lawn mower. The control method can achieve the effect of adjusting the gear of the lawn mower remotely in an accurate, real-time, and intelligent manner. The gear refers to the mowing gear of the lawn mower. In the case that the lawn mower operates in different gears, the mowing power system of the lawn mower outputs according to different parameters such as power and a rotational speed to adapt to different grass conditions. For example, when the lawn mower travels across an area with denser grass, the power output needs to be increased, and when the lawn mower travels across an area with sparser grass, the power output needs to be reduced. By adjusting the gear of the lawn mower, the power output of the mowing system or the mowing blade can be adjusted.

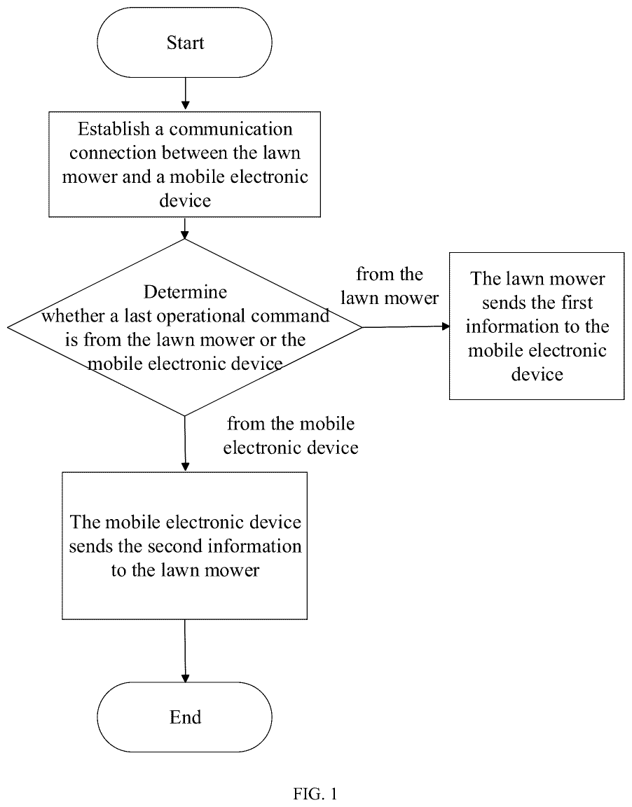

As shown in FIG. 1, the control method includes the following steps: establishing a communication connection between the lawn mower and a mobile electronic device; then determining whether an operational command for a last adjustment of the work gear of the lawn mower is received from the lawn mower or the mobile electronic device. Based on the determination results, the method further includes: in response to a determination that the operational command is received from the lawn mower, the lawn mower sends first information including the adjusted work gear to the mobile electronic device, and the mobile electronic device records and outputs externally the first information; and in response to a determination that the operational command is received from the mobile electronic device, the mobile electronic device sends second information including the operational command to the lawn mower, and the lawn mower adjusts the work gear according to the received second information.

In some embodiments, the lawn mower is configured to: in the case that the communication connection is established between the lawn mower and the mobile electronic device, send third information including a suggestion of adjusting the work gear to the mobile electronic device. That is, after the third information is sent to the mobile electronic device, the user who can operate the mobile electronic device confirms whether the content in the third information is to be executed. The content of the suggestion of adjusting the work gear includes a suggestion of adjusting the work gear and an inquiry about whether to adjust the work gear. For example, the suggestions are as follows: a suggestion of increasing the gear is provided when the load is high; and a suggestion of decreasing the gear is provided when the load is low, etc. The aforementioned suggestions can be put forward by the lawn mower based on the analysis of working conditions including the monitored operational parameters of the motor or the mowing blade or the grass density, as well as comparison between the current gear of the lawn mower and the gear adjustment command sent by the mobile electronic device. That is, when the operational command is received from the mobile electronic device, the lawn mower sends the third information to the mobile electronic device based on the real-time load. The user can receive the suggestion information through the lawn mower, especially through the mobile electronic device, and determine whether to adjust the gear according to the suggestion. The gear adjustment operation includes operating the gear adjustment mechanism of the lawn mower or performing the gear adjustment operation on the mobile electronic device. The gear adjustment operation is not limited to manual operation, and can also be performed through voice, head movements, or foot movements, etc. Of course, the user can also set a mode where the lawn mower automatically accepts the suggestions in the third information without the need for the user's judgment and operation.

In some embodiments, the work gear includes a plurality of fixed gears corresponding to different rotational speed values. Each of the fixed gears corresponds to a threshold range of the load of the lawn mower. For example, the fixed gears include a first gear, a second gear, and a third gear (of course, two gears, four gears, or more gears can be set). The loads of the lawn mower corresponding to the first gear, the second gear, and the third gear increase (or decrease) in sequence. Each gear corresponds to a distinct mowing output intensity (such as a different rotational speed) of the lawn mower, and thus is adapted to accommodate different load conditions. The load conditions are affected by the working conditions, mainly the grass conditions. The load conditions can be determined manually or based on the monitored operational parameters of the motor or the mowing blade or the grass density. Each fixed gear corresponds to a threshold range of the load condition of the lawn mower, such as the monitored variation range of the rotational speed of the mowing blade or the mowing motor, the variation range of the voltage or current of the mowing motor, etc. The lawn mower includes a cutting element, and the lawn mower executes the command for the fixed gear to adjust the rotational speed of the cutting element to the rotational speed value corresponding to the respective gear, thereby meeting the output requirement corresponding to the executed fixed gear.

In some embodiments, the work gear further includes an automatic gear corresponding to a variable rotational speed value. The automatic gear corresponds to a non-fixed rotational speed value of the cutting element. In the process that the lawn mower operates in the automatic gear mode, the lawn mower adjusts the rotational speed of the cutting element according to the real-time load. For example, the lawn mower automatically increases the rotational speed when the load becomes higher and automatically decreases the rotational speed when the load becomes lower. During the adjustment of the gear of the lawn mower when the lawn mower operates in the automatic gear mode, the stepped speed regulation used for the fixed gears (i.e., the rotational speed corresponding to each gear is a preset fixed value) is not required, but instead automatic stepless speed regulation is adopted, which can realize precise and automatic control of the lawn mower, improve the mowing efficiency, and reduce energy consumption.

In some embodiments, during the operation of the lawn mower, the load condition of the lawn mower can be obtained in the following manners: collecting the operational parameters of the power source that drives the cutting element, and then identifying the real-time load of the lawn mower based on the operational parameters. In one embodiment, the cutting element is a mowing blade, and the power source is a motor that drives the mowing blade. The operational parameters include one or more parameters selected from a group including a rotational speed, PWM (Pulse Width Modulation) duty cycle, voltage, current, and freewheeling time. The principle of determining the magnitude and change of the load based on the operational parameters of the motor belongs to the related art and will not be described in detail here. Identifying the real-time load of the lawn mower based on the operational parameters can realize real-time and automatic load monitoring, and solve the problem of incorrect and inaccurate gear adjustment of the lawn mower caused by errors in manual load determination.

In some embodiments, the lawn mower includes both fixed gears and an automatic gear. For example, there are four gears, which are a first gear, a second gear, a third gear, and an automatic gear respectively. When one of the first gear, the second gear, or the third gear is selected by the user, stepped speed regulation is adopted. That is, the rotational speed corresponding to each gear is a preset fixed value, while when the automatic gear is selected, automatic stepless speed regulation is adopted. For the stepped speed regulation of each of the first gear, the second gear, and the third gear, a fixed rotational speed is set for the motor. The higher the rotational speed, the greater the energy consumption; the lower the rotational speed, the smaller the energy consumption. For the convenience of operation, users usually directly select the third gear to cope with all load conditions, which causes a certain degree of energy waste when the grass is sparse and the load is low. Therefore, the combination of the automatic gear and the load-adaptive adjustment of the operational parameters of the power source can solve the above problem: the control unit of the lawn mower collects relevant parameters such as the rotational speed, PWM duty cycle, voltage, current, and freewheeling time of the mowing motor during operation, identifies the load condition, and automatically adjusts the rotational speed of the power source according to the load. Of course, the control unit can also collect real-time parameters in other units or circuits of the lawn mower to comprehensively determine the load condition, such as the current and voltage changes at the power input end of the electric utility vehicle, which belong to the same principle and will not be described in detail here.

In some embodiments, the mobile electronic device includes a mobile phone, a handheld remote control device, etc. The step of recording and outputting externally the first information by the mobile electronic device specifically includes: storing the first information by the mobile phone, displaying the first information on the display screen of the mobile phone, and/or playing the first information through the speaker or earphones of the mobile phone. The first information is the current work gear information of the lawn mower after the work gear of the lawn mower is adjusted. The mobile phone receives and records the work gear information, and transmits it to the user through the mobile phone terminal. The user receives the information by observing the display screen of the mobile phone, listening to the prompt sound emitted by the mobile phone, etc. The mobile phone can realize information interaction with the lawn mower through the APP software installed on the mobile phone. On the other hand, when the user sends an operational command by operating the mobile phone or the APP, that is, when the operational command for adjusting the work gear is received from the mobile phone, the mobile phone sends second information including the operational command to the lawn mower, and the lawn mower adjusts its work gear according to the received second information.

The popularization and application of mobile phones, especially smart phones, enable users to remotely control the operation mode including the gear of the lawn mower, and provide the possibility for customizing the automatic gear adjustment plan of the lawn mower, making the use of the lawn mower safer and more intelligent. Of course, the mobile electronic device can include not only mobile phones but also laptop computers, smart wristbands, electronic watches, and other portable or wearable electronic devices. The mobile electronic device including the mobile phone can also be used to start or shut down the lawn mower, adjust the number of the aforementioned fixed gears, the load threshold range and output rotational speed corresponding to each fixed gear, and select different fixed gears or the automatic gear, etc.

In some embodiments, the mobile electronic device can be connected to the Internet and upload the first information and the second information to the cloud server. The cloud server can be provided by a brand owner, a retailer, a manufacturer, or a service provider of the lawn mower. For example, when the mobile electronic device is a mobile phone, the mobile phone APP records the information of the gear adjustment performed and the received gear information sent by the lawn mower, and then uploads the information to the cloud using the MQTT protocol, UDP protocol, or 4G TCP/IP protocol. By integrating the data on the cloud, the usage records of each gear are generated, and then optimization processing is performed according to the usage of each gear, which can be used to further improve the user experience.

In some embodiments, to facilitate the intelligent management of the lawn mower and prevent theft or unsafe use of the lawn mower, after the communication connection is established between the lawn mower and the mobile electronic device, the method further includes the following steps: sending, by the mobile electronic device, a request for acquiring a device ID to the lawn mower; then upon receiving the request, sending, by the lawn mower, the device ID to the mobile electronic device; and connecting the mobile electronic device to the Internet and searching the cloud server for a determination of whether the device ID has usage permission. In response to a determination that the mobile electronic device has the usage permission, the lawn mower is allowed to execute the operational command from the mobile electronic device, and the mobile electronic device is enabled to upload the first information and the second information to the cloud server. In response to a determination that the mobile electronic device does not have the usage permission, the lawn mower is prohibited from executing the operational command from the mobile electronic device.

In some embodiments, a user ID corresponding to the device ID is pre-stored in the cloud server. When the mobile electronic device is connected to the Internet and searches the cloud server for a determination of whether the device ID has usage permission, the method specifically includes: the determination of whether the device ID has usage permission is performed based on a determination of whether the mobile electronic device has the user ID corresponding to the device ID. During searching the cloud server for a determination of whether the device ID has usage permission, it is to determine whether the device ID corresponds to the user ID carried by the mobile electronic device. If the user ID corresponding to the device ID recorded in the cloud server is inconsistent with the user ID that sends the request currently, or the mobile electronic device does not have a valid user ID, it is determined that there is no usage permission.

In one embodiment, each lawn mower has a unique device ID, and the device ID can include parts such as production time, a machine model, and a machine serial number. The device ID is automatically generated during the production of the ride-on lawn mower. After the upper computer generates the device ID, the number of the device ID is sent to a programming tool, then the programming tool sends the device ID to the lawn mower through a serial port or other forms, and finally the lawn mower stores the received device ID in the internal Flash storage area. When the user purchases the lawn mower, the seller can create a user account for the user, and the account includes: a user ID, purchase time, an owned device ID, etc. One user ID can correspond to multiple device IDs, and each time the user purchases a product, the corresponding device ID can be added to the user's management account.

In some embodiments, the communication connection includes a WIFI connection, a Bluetooth connection, and a data cable connection. The lawn mower is a ride-on lawn mower.

The implementation scenario of the wireless connection and management between the ride-on lawn mower and the mobile phone is as follows. The ride-on lawn mower is started, the Bluetooth module is powered on, and the Bluetooth of the mobile phone is connected to the Bluetooth of the ride-on lawn mower. The mobile phone sends a request for acquiring the device ID to the ride-on lawn mower, and the ride-on lawn mower sends the stored device ID to the mobile phone upon receiving the request. The mobile phone queries the user account from the cloud server backend through the Internet to determine whether the device ID is the device ID owned by the user. If the device ID is the device ID owned by the user, the mobile phone is allowed to send command information including work gear adjustment to the ride-on lawn mower. If the device ID is not the device ID owned by the user, the mobile phone is prohibited from performing remote gear adjustment on the ride-on lawn mower. In addition to the wireless connection through the Bluetooth module, a wireless connection can also be established through the WIFI module. When the ride-on lawn mower is started, the built-in WIFI module is powered on, and the mobile phone and the WIFI module are connected to the same wireless router, so that the WIFI connection is realized through the wireless router.

The implementation scenario of remotely controlling the gear of the ride-on lawn mower is as follows: the device ID is stored in the ride-on lawn mower, and the user ID needs to be bound to the mobile phone APP. After a wireless connection is established between the mobile phone and the ride-on lawn mower, the device ID is queried, and the binding relationship between the device ID and the user ID is established. For the ride-on lawn mower, the working condition parameters such as rotational speed, PWM duty cycle, voltage, current, and freewheeling time during operation are processed to obtain the load condition (high load/low load). The current load information and gear information are sent to the mobile phone after the connection is established between the ride-on lawn mower and the mobile phone. After the mobile phone adjusts the gear, it sends the gear value to the ride-on lawn mower, and the ride-on lawn mower adjusts the gear according to the received gear value. The device that performs the last gear adjustment operation has the control right of the ride-on lawn mower, and the gear value of the other device needs to be synchronized with the gear value of the control end. Based on the real-time load information of the ride-on lawn mower, the user usage record of the ride-on lawn mower can be generated. In the event that the device ID, the user ID, and the real-time load information are obtained, the remote gear control of the ride-on lawn mower can be realized.

The implementation scenario of remote gear control and information synchronization between the ride-on lawn mower and the mobile phone is as follows: a wireless connection is established between the mobile phone and the ride-on lawn mower; a device that performs the last gear adjustment operation is determined, such device is configured as the master device, and the other device is configured as the slave device. When the master device is the mobile phone, the mobile phone sends an operational command for adjusting the work gear to the ride-on lawn mower, and the gear of the ride-on lawn mower is changed according to the command. Accordingly, the gear indicator light, rotational speed, duty cycle, etc. are changed During this period, the ride-on lawn mower sends the load condition to the mobile phone and puts forward a suggestion of adjusting the work gear (for example: the current load is high, whether to shift to a higher gear?). When the master device is the ride-on lawn mower, the ride-on lawn mower sends the current gear value to the mobile phone, and the gear value on the interface of the mobile phone APP changes, realizing the gear synchronization between the two devices.

The present application enables users to remotely control the lawn mower by establishing a communication connection between the lawn mower and the mobile electronic device. The mobile electronic device can update, record, and output the gear status of the lawn mower in real time, achieving the effects of remote monitoring and intelligent management. The lawn mower can adjust the gear automatically, which not only can adjust the output of the mowing blade according to the grass condition to improve the overall battery life of the lawn mower, but also enables users to eliminate the need for the manual gear adjustment operation, which is very safe and convenient.

### Embodiment 2

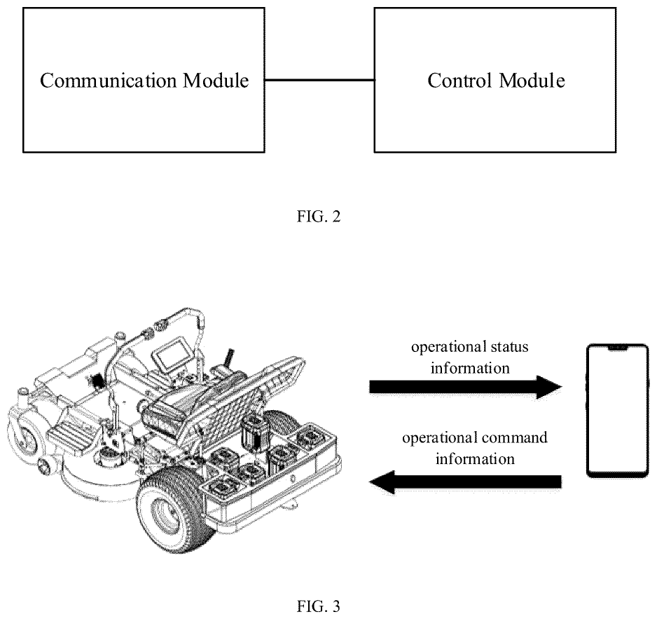

As illustrated in FIG. 2, the present application further provides a lawn mower, including a communication module and a control module. The communication module is configured to establish a communication connection between the lawn mower and a mobile electronic device. The control module is configured to determine whether an operational command for the last adjustment of the work gear of the lawn mower is received from the lawn mower or the mobile electronic device. In response to a determination that the operational command is received from the lawn mower, the lawn mower is configured to send first information including the adjusted work gear to the mobile electronic device, and the mobile electronic device is configured to record and output externally the first information. In response to a determination that the operational command is received from the mobile electronic device, the mobile electronic device is configured to send second information including the operational command to the lawn mower, and the lawn mower is configured to adjust the work gear according to the received second information. For the lawn mower provided in the present application, the division of the aforementioned modules is only an exemplary description, and the communication module and the control module can also be integrated into one module to realize the communication and control functions.

The present application enables users to remotely control the lawn mower by establishing a communication connection between the lawn mower and the mobile electronic device; the mobile electronic device can update, record, and output the gear status of the lawn mower in real time, achieving the effects of remote monitoring and intelligent management. The lawn mower can adjust the gear automatically, which not only can adjust the output of the mowing blade according to the grass condition to improve the overall battery life of the lawn mower, but also enables users to eliminate the need for the manual gear adjustment operation, which is very safe and convenient.

### Embodiment 3

The present application further provides a lawn mower for implementing the control method described in Embodiment 1, including a memory and a processor. The memory stores computer instructions; the processor is connected to the memory and configured to obtain and execute the computer instructions in the memory to implement the aforementioned control method.

The present application enables users to remotely control the lawn mower by establishing a communication connection between the lawn mower and the mobile electronic device. The mobile electronic device can update, record, and output the gear status of the lawn mower in real time, achieving the effects of remote monitoring and intelligent management. The lawn mower can adjust the gear automatically, which not only can adjust the output of the mowing blade according to the grass condition to improve the overall battery life of the lawn mower, but also enables users to eliminate the need for the manual gear adjustment operation, which is very safe and convenient.

### Embodiment 4

The present application further provides a computer-readable medium including a non-volatile program code executable by a processor. The program code is executed by the processor to implement the aforementioned control method.

The present application enables users to remotely control the lawn mower by establishing a communication connection between the lawn mower and the mobile electronic device. The mobile electronic device can update, record, and output the gear status of the lawn mower in real time, achieving the effects of remote monitoring and intelligent management. The lawn mower can adjust the gear automatically, which not only can adjust the output of the mowing blade according to the grass condition to improve the overall battery life of the lawn mower, but also enables users to eliminate the need for the manual gear adjustment operation, which is very safe and convenient.

If the functions are implemented in the form of software functional units and sold or used as independent products, they can be stored in a computer-readable storage medium. Based on this understanding, the technical solution of the present application essentially, or the part that contributes to the related art, or part of the technical solution can be embodied in the form of a software product. The computer software product is stored in a storage medium and includes several instructions to enable a computer device (which can be a personal computer, a server, or a network device, etc.) to execute all or part of the steps of the method described in each embodiment of the present application. The aforementioned storage medium includes: a USB flash drive, a mobile hard disk, a Read-Only Memory (ROM), a Random Access Memory (RAM), a magnetic disk, an optical disk, and other media that can store program codes.

### Embodiment 5

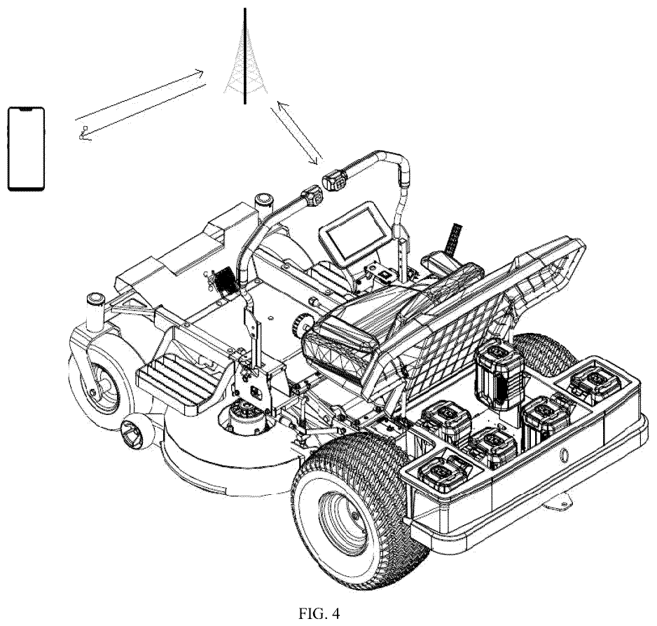

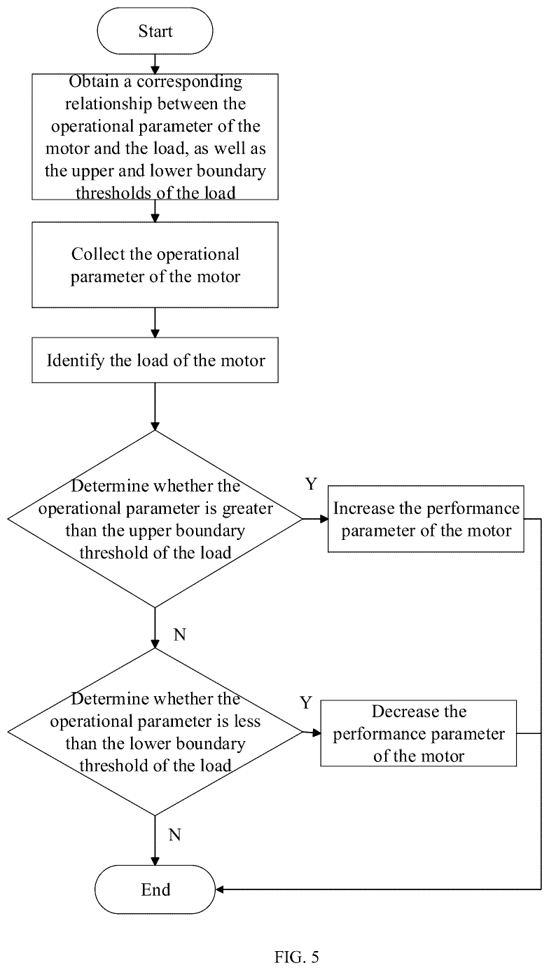

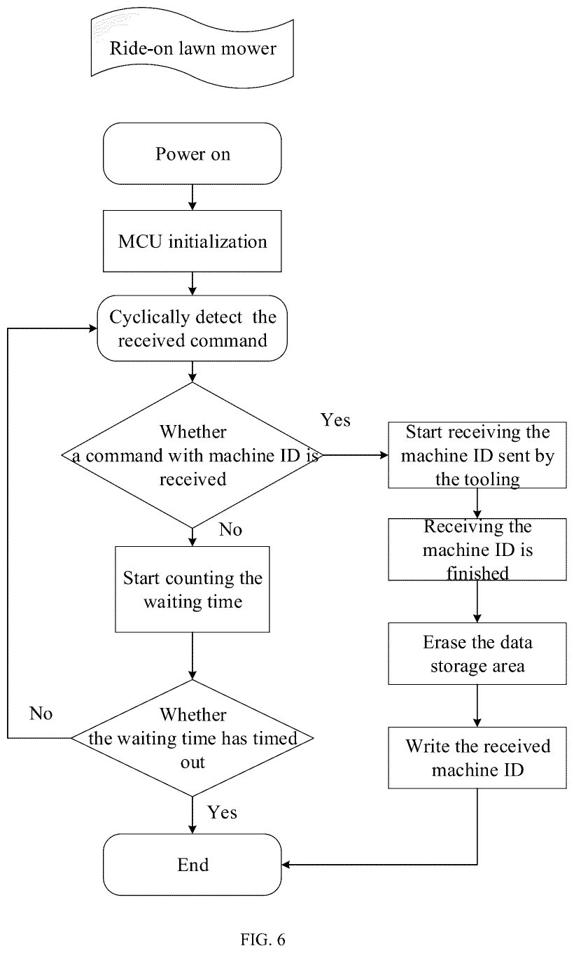

As shown in FIG. 3 to FIG. 4, the present application further provides an electric utility vehicle system. The vehicle system includes an electric utility vehicle and a mobile electronic device, and the mobile electronic device can be a mobile terminal such as a mobile phone or a remote controller. The electric utility vehicle includes a control system. The control system includes an operational status information acquisition unit, an information storage unit, an information transmission unit, and an operational control unit. The operational status information acquisition unit is configured to acquire the operational status information of the electric utility vehicle; the information storage unit is configured to store the acquired operational status information data; the information transmission unit is configured to transmit externally the acquired operational status information data to the mobile electronic device through wireless communication and receive operational command information for the electric utility vehicle from the mobile electronic device; the operational control unit is configured to control the execution component of the electric utility vehicle to perform corresponding operations according to the received operational command information.

The following electric utility vehicle takes a ride-on lawn mower as an example. The ride-on lawn mower has the functions of traveling and mowing, and its execution components include a traveling motor and/or a work motor. Of course, the electric utility vehicle can also be an outdoor utility vehicle such as a snow sweeper, a seeder, or a rice transplanter. In this embodiment, the work motor is a cutting motor configured to drive the mowing blade to operate.

The following operational command information for the electric utility vehicle takes the command information for adjusting the gear of the cutting motor of the ride-on lawn mower as an example. The ride-on lawn mower has a plurality of fixed gears such as a first gear, a second gear, and a third gear, and an Auto automatic gear. Of course, the operational command information can also be command information for adjusting other operational status of the ride-on lawn mower, such as command information for adjusting the traveling speed, command information for adjusting the height of the cutter head, command information for grass collection and/or grass discharge, command information for adjusting the height of the driving wheel, command information for straight-line calibration, command information for battery pack discharge management, command information for braking and/or parking, etc.

In the fixed gear mode, the user monitors the operational status information of the ride-on lawn mower in real time, and sends operational command information for adjusting the gear of the work motor of the ride-on lawn mower through the operation interface on the mobile electronic device or the operation assembly on the ride-on lawn mower according to the operational status information.

In the Auto automatic gear mode, the mobile electronic device and/or the ride-on lawn mower automatically parses the received operational status information to generate operational command information matching the operational status information. In this mode, the user does not need to stare at the screen of the mobile electronic device in real time to monitor the operational status information of the ride-on lawn mower.

The first gear, the second gear, the third gear, and the Auto gear are set for the work motor in the electric utility vehicle and the App on the mobile phone terminal. The user can adjust the gear through the App according to the grass with different densities to replace the operation on the utility vehicle, or directly select the Auto gear to allow the App to perform load adaptation according to the received real-time load condition. In another case, the electric utility vehicle does not have the load adaptation function, that is, does not have the Auto automatic gear mode. For this case, the function of load adaptation of the utility vehicle can still be realized by inputting a program for automatically adjusting the gear according to the work load into the mobile phone App. The mobile phone App sends operational command information for adjusting the gear to switch the gear of the work motor according to the received different load information.

The operational status information includes parameter information of the ride-on lawn mower during operation and/or hardware information of the ride-on lawn mower, such as: gear information of the cutting motor during operation, real-time load information, traveling speed information, battery power information, working time information, vehicle fault information, brand information, ID information, and information about the external environment. In the manual mode, the user determines whether to adjust the current operational status of the ride-on lawn mower according to the information. In the Auto automatic mode, the mobile electronic device or the ride-on lawn mower automatically determines whether to adjust the current operational status of the ride-on lawn mower according to the information.

The operational status information can be acquired through sensors arranged on the ride-on lawn mower, or through monitoring the operational parameters of the cutting motor and/or the traveling motor. For example: data such as rotational speed, PWM duty cycle, voltage, current, and freewheeling time during operation can be processed to obtain the load condition of the cutting motor.

The mobile electronic device includes a first communication module, the electric utility vehicle includes a second communication module, and the second communication module is connected to the first communication module through wireless communication. After the user sends operational command information for adjusting the gear of the ride-on lawn mower through the mobile electronic device, the gear value is transmitted to the ride-on lawn mower through wireless communication, and the ride-on lawn mower adjusts the gear according to the received gear value. After the user adjusts the gear through the gear adjustment operation assembly on the ride-on lawn mower, the ride-on lawn mower synchronizes the adjusted gear information to the mobile electronic device through wireless communication.

The mobile electronic device has a built-in first application program for interacting with the ride-on lawn mower. The user triggers the operational information command for the ride-on lawn mower through the icon on the graphical interface corresponding to the first application program. Of course, the mobile electronic device also has a display interface for displaying the operational status information of the ride-on lawn mower, user usage records, adjusted gear information, and/or information about the external environment. For example, the information about the external environment includes grass density information, grass height information, weather information, etc.

In some embodiments, the mobile electronic device has an operation interface for receiving user operation information. The user triggers the operation interface to issue operational command information directed to the electric utility vehicle. The operation interface includes at least one of the followings: electronic/physical buttons, a handle, an operating interface, a voice recognition component, etc. In some embodiments, the operation interface includes a human-computer interaction interface. After the lawn mower sends the operational parameter information to the mobile electronic device through wireless communication, according to the operational parameter information, the mobile electronic device sends information prompting the user to adjust the gear and the suggested adjusted gear. The mobile electronic device prompts the user through either of the following approaches: through the display interface or through voice. In response to the prompt, the user determines whether to shift the gear through the operation interface.

The ride-on lawn mower is provided with an operation assembly. The user controls the work gear of the mowing motor of the ride-on lawn mower through the operation assembly. In the state where the ride-on lawn mower and the mobile electronic device are in communication connection, the mobile electronic device acquires the real-time load information and the gear value. Specifically, the data information of the ride-on lawn mower can be synchronized to the mobile electronic device at certain intervals, or the changed operational status information can be automatically synchronized to the mobile electronic device after the operation assembly of the ride-on lawn mower is triggered.

In some embodiments, the step of automatically matching the work gear by the control unit according to the load includes: pre-storing a corresponding relationship between the operational parameters of the motor and the load as well as the upper and lower boundary thresholds of the load in the memory of the control unit; collecting the operational parameters of the motor, where the operational parameters include at least one of duty cycle, a rotational speed, current, and power; identifying the load of the motor based on the operational parameters of the motor; comparing with the corresponding relationship between the operational parameters of the motor and the load, if the operational parameter is greater than the upper boundary threshold of the load, increasing the performance parameters of the motor, and if the operational parameter is less than the lower boundary threshold of the load, decreasing the performance parameters of the motor. The performance parameters of the motor include power, a rotational speed, current, and torque.

In some embodiments, the control unit module for automatically matching the work gear according to the load can be arranged on the ride-on lawn mower or on the mobile electronic device. The control unit module is configured to calculate and/or simulate the work gear and/or the rotational speed of the cutting motor matching the load according to the real-time load. When the control unit module is located on the mobile electronic device, the mobile electronic device parses the received operational status information of the ride-on lawn mower to generate a gear value and/or a motor rotational speed value that matches the operational status information, and transmits the operational command information including the gear value and/or the motor rotational speed value to the operational control unit of the ride-on lawn mower through wireless communication, realizing low-power gear output when the load is low and high-power gear output when the load is high. This makes the control and output adjustment of the work motor more accurate and improves the battery life of the ride-on lawn mower.

In some embodiments, one mobile electronic device ID can be bound to multiple ride-on lawn mower IDs at the same time, and one ride-on lawn mower ID can be bound to only one user ID at the same time. After a wireless connection is established between the mobile electronic device and the ride-on lawn mower, in the App, it is allowed to check whether the ID of the ride-on lawn mower belongs to the user ID. Specifically, each ride-on lawn mower has a unique machine ID, and the machine ID includes parts such as a production time, a machine model, and a machine serial number, etc. The machine ID is automatically generated during the production of the ride-on lawn mower. After the upper computer generates the machine ID, the number of the machine ID is sent to the programming tool, then the programming tool sends the machine ID to the ride-on lawn mower through a serial port or other forms, and finally the ride-on lawn mower stores the received machine ID in the internal Flash storage area. When the user purchases the ride-on lawn mower, the seller can create a user account for the user, and the account includes: a user ID, purchase time, and an owned machine ID, etc. Each time the user purchases a product, the corresponding machine ID can be added to the user's management account. The process of wireless connection and management between the ride-on lawn mower and the mobile phone is as follows: 1) The ride-on lawn mower is started, the Bluetooth module is powered on, and the Bluetooth of the mobile phone is connected to the Bluetooth of the ride-on lawn mower; 2) The mobile phone sends a request for acquiring the machine ID to the ride-on lawn mower, and the ride-on lawn mower sends the stored machine ID to the mobile phone upon receiving the request; 3) The mobile phone queries the user account from the server backend through the Internet to check whether the machine ID is the machine ID owned by the user. If the machine ID is the machine ID owned by the user, the mobile phone is allowed to send a gear adjustment command to the ride-on lawn mower. If the machine ID is not the machine ID owned by the user, the mobile phone is prohibited from performing remote gear adjustment on the ride-on lawn mower. In addition to the wireless connection through the Bluetooth module, a wireless connection can also be established through the WIFI module. When the ride-on lawn mower is started, the built-in WIFI module is powered on, and the mobile phone App and the WIFI module are connected to the same wireless router, so that the WIFI connection is realized through the wireless router; the other steps are the same as above.

The ride-on lawn mower transmits the operational status information of the ride-on lawn mower to the mobile electronic device through wireless communication, and the mobile electronic device controls the working components of the ride-on lawn mower to perform corresponding operations through the wireless communication. The aforementioned wireless communication refers to receiving status information and/or command information by using one of following wireless communications: BLE (Bluetooth Low Energy) communication technology, WLAN (Wireless Local Area Network) communication technology, Zigbee wireless communication technology, UWB (Ultra-Wideband) wireless communication technology, EnOcean communication technology, Z-Wave communication technology, and NFC (Near Field Communication) technology.

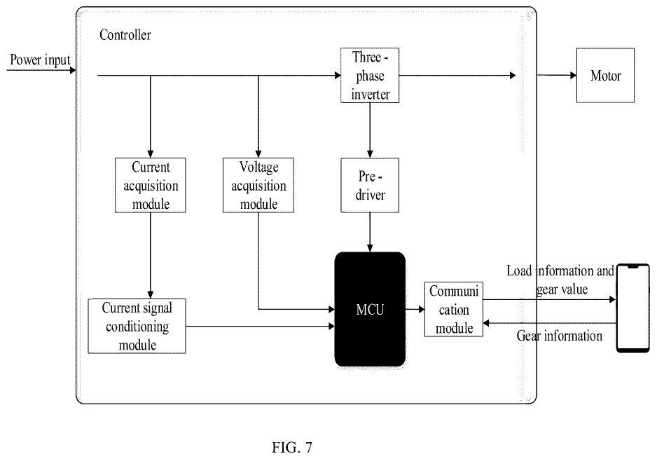

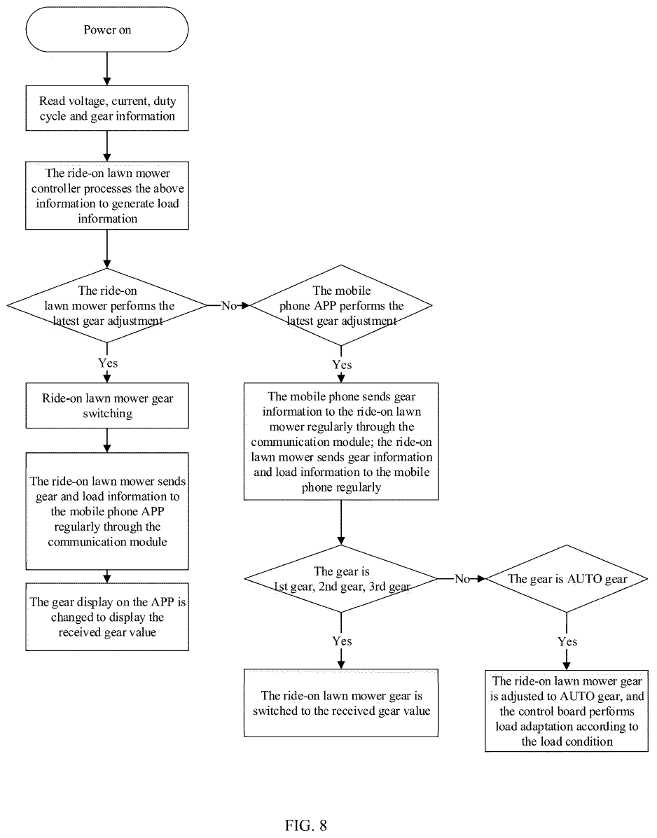

As shown in FIG. 7, a current acquisition module and a voltage acquisition module are included in the controller of the ride-on lawn mower. Information interaction between the MCU (Microcontroller Unit) and the mobile phone App is realized through the communication module. The MCU processes the acquired voltage, current, and PWM information to obtain the corresponding load condition (which may include a high load, a medium load, and a low load, and the load conditions can be distinguished according to the gear), and sends the load condition and the current gear to the mobile phone App through the communication module. At the same time, the gear control command sent by the mobile phone App is received through the communication module. The gear control of the ride-on lawn mower includes two cases: Case 1: The last gear control is performed by the ride-on lawn mower; Case 2: The last gear control is performed by the mobile phone App. For Case 1, the ride-on lawn mower is set as the master device, and the ride-on lawn mower sends the current gear information and load to the mobile phone App, and the gear on the mobile phone App is updated to the received gear value. For Case 2, the mobile phone is set as the master device, and the mobile phone sends a gear adjustment command to the ride-on lawn mower. The ride-on lawn mower adjusts the gear according to the command, and the corresponding duty cycle, gear display, etc. are adjusted accordingly. The ride-on lawn mower sends the load information and gear information to the mobile phone. If the current gear does not match the current load information, the App can remind the user whether to adjust the gear. The software flowchart is shown in FIG. 8. In this solution, there are four gears, which are a 1st gear, a 2nd gear, a 3rd gear, and an AUTO gear respectively. When each of the 1st gear, 2nd gear, or 3rd gear is selected by the user, stepped speed regulation is adopted. That is, the rotational speed corresponding to each gear is a preset fixed value, while automatic stepless speed regulation is adopted when the AUTO gear is selected.

The energy consumption of the ride-on lawn mower is related to two parts: the energy required for carrying the user and the energy consumed by the mowing motor. For the stepped speed regulation of each of the 1st gear, the 2nd gear, and the 3rd gear mentioned above, a fixed rotational speed is set for the motor. The higher the rotational speed, the greater the energy consumption. On the other hand, the lower the rotational speed, the smaller the energy consumption. For the convenience of operation, users usually directly select the 3rd gear to cope with all load conditions, which causes a certain degree of energy waste. Therefore, the AUTO gear load adaptation function is developed to solve the above problem. The control board collects relevant parameters such as the rotational speed, PWM duty cycle, voltage, current, and freewheeling time of the ride-on lawn mower during operation, identifies the load condition, and realizes automatic adjustment of the rotational speed according to the load. As shown in FIG. 4, the mobile phone App records the information of the gear adjustment performed by the App and the gear information sent by the received control board, and then uploads the information to the cloud using the MQTT protocol, UDP protocol, or 4G TCP/IP protocol. Developers integrate the data on the cloud to generate the usage records of each gear, and then perform optimization processing according to the usage of each gear, thereby further improving the user experiences.

In some embodiments, the control system of the electric utility vehicle can include multiple controller components with different functions, or can be an integrated controller component. The controller component controls the traveling motor, the work motor, and the overall operational status of the utility vehicle. The integrated controller component is integrally provided with multiple traveling control units, multiple power output control units, and a vehicle control unit. The multiple traveling control units are configured to control the multiple traveling motors respectively, and the multiple power output control units are configured to control the multiple work motors respectively. The vehicle control unit is configured to control the overall operational status of the multi-functional vehicle. The integrated controller component being integrally provided with the multiple traveling control units, the multiple power output control units, and the vehicle control unit means that the circuit components corresponding to the multiple control units are at least partially integrally arranged on at least one circuit board. For example, all the circuit components of the multiple control units can be integrally arranged on one circuit board. The circuit board can be a PCB (Printed Circuit Board) or an aluminum substrate. The selection of the aluminum substrate is beneficial to heat dissipation of the multiple integrally arranged control units.

The integrated controller component is configured that the multiple traveling control units for controlling the multiple traveling motors, the at least one power output control unit for controlling the at least one work motor, and the vehicle control unit for executing the vehicle status control are integrated into a single unit in an integrated manner. In the embodiment of this specification, the number of the power output motors, the number of the output components, and the number of the corresponding power output control units in the multi-functional vehicle each can be exemplarily set to three respectively.

In the integrated controller component, the components in each control unit can be arranged closely, and the communication and power transmission lines between the multiple control units are also arranged integrally. This arrangement can greatly reduce the number of required wire harnesses and terminal posts, effectively reduce costs, improve the efficiency of product production, assembly, testing, and commissioning, and effectively improve the safety and stability of the entire machine.

The ride-on lawn mower further has a power supply system for supplying power to the traveling motor and the work motor, and the power supply system includes multiple battery units. The multiple battery units can be at least one of a first-specification battery pack and a second-specification battery pack. The specification differences between the first-specification battery pack and the second-specification battery pack include, but are not limited to, differences in battery pack capacity, voltage, battery internal resistance, weight, size, energy density, cell type, state of charge information, battery health status information, etc.

In some optional embodiments, the difference between the first-specification battery pack and the second-specification battery pack lies in the different battery pack capacities. The capacity of the first-specification battery pack is greater than that of the second-specification battery pack. The second-specification battery pack is configured to supply power to handheld landscaping tools. For example, the second-specification battery pack can supply power to garden tools such as grass trimmers, hedge trimmers, blowers, and chainsaws. In addition, the second-specification battery pack can also supply power to torque output tools such as electric drills and electric hammers; supply power to cutting tools such as electric circular saws, jigsaws, and reciprocating saws; or supply power to grinding tools such as angle grinders and sanders.

In some optional embodiments, the difference between the first-specification battery pack and the second-specification battery pack lies in the different types of cells used. For example, the first-specification battery pack and the second-specification battery pack can include lithium iron phosphate cells and ternary lithium cells respectively. The multiple battery units in the power supply system can also be configured to include nickel-chromium battery cells, lead-acid battery cells, graphene cells, etc.

The multiple battery units included in the power supply system are at least one of the first-specification battery pack and the second-specification battery pack. This configuration enables the multi-functional vehicle to be compatible with battery packs of different specifications, which not only meets the high-power operation requirements, but also is adaptable to handheld electric landscaping tools, making the working mode of the staff more flexible.

In some embodiments, the electric multi-functional vehicle can be a garden work vehicle capable of performing garden work such as garden pruning, mowing, and spraying. In some embodiments, the electric multi-functional vehicle can be a cleaning vehicle such as a snow sweeper. In some embodiments, the electric multi-functional vehicle can be an agricultural work vehicle such as a seeder or a tractor. In some embodiments, the electric multi-functional vehicle can be a handling vehicle such as a forklift. In some embodiments, the electric multi-functional vehicle can be an off-road vehicle such as a Utility Task Vehicle (UTV). In some embodiments, the electric multi-functional vehicle may require user operation. Alternatively, the electric multi-functional vehicle can be self-propelled/intelligent, that is, it can plan the navigation route by itself, walk automatically, avoid obstacles, etc.

Finally, it should be noted that the above-mentioned embodiments are only specific implementations of the present application and are used to explain the technical solutions of the present application, rather than limiting the present application. The protection scope of the present application is not limited thereto. Although the present application has been described in detail with reference to the foregoing embodiments, those of ordinary skill in the art should understand that any person skilled in the art can still modify the technical solutions described in the foregoing embodiments or easily conceive of variations within the technical scope disclosed in the present application, or make equivalent substitutions for some of the technical features thereof; and these modifications, changes, or replacements do not make the essence of the corresponding technical solutions deviate from the spirit and scope of the technical solutions of the embodiments of the present application, and all of them should fall into the protection scope of the present application. Therefore, the protection scope of the present application should be subject to the protection scope of the claims.

What is claimed is:

1. A method for controlling an electric utility vehicle, comprising:
establishing a communication connection between the electric utility vehicle and a mobile electronic device;
determining whether an operational command for a last adjustment of a work gear of the electric utility vehicle is received from the electric utility vehicle or the mobile electronic device;
in response to a determination that the operational command is received from the electric utility vehicle, sending, by the electric utility vehicle, first information comprising the adjusted work gear to the mobile electronic device, and recording and outputting externally, by the mobile electronic device, the first information; and
in response to a determination that the operational command is received from the mobile electronic device, sending, by the mobile electronic device, second information comprising the operational command to the electric utility vehicle, and adjusting, by the electric utility vehicle, the work gear according to the received second information.

2. The method according to claim 1, wherein the electric utility vehicle is configured to: in a case that the communication connection is established between the electric utility vehicle and the mobile electronic device, send third information to the mobile electronic device for user confirmation, the third information comprising a determination as to whether the work gear is to be adjusted as well as the adjusted work gear; and
wherein the method comprises: in response to a determination that the operational command is received from the mobile electronic device, sending, by the electric utility vehicle, the third information to the mobile electronic device based on a real-time load.

3. The method according to claim 1, wherein:
the work gear comprises a plurality of fixed gears corresponding to different rotational speed values,
the electric utility vehicle comprises a cutting element, and
the electric utility vehicle is configured to execute a command for one of the plurality of fixed gears, to adjust a rotational speed of the cutting element to a rotational speed value corresponding to the respective gear of the plurality of fixed gears;
the work gear further comprises an automatic gear corresponding to a variable rotational speed value, and
the electric utility vehicle is configured to execute a command for the automatic gear to adjust the rotational speed of the cutting element based on a real-time load of the electric utility vehicle.

4. The method according to claim 3, further comprising:
during operation of the electric utility vehicle, collecting operational parameters of a power source for driving the cutting element;
based on the operational parameters, identifying a real-time cutting load of the electric utility vehicle;
wherein the operational parameters comprise one or more parameters selected from a group comprising a rotational speed, PWM duty cycle, voltage, current, and freewheeling time.

5. The method according to claim 1, wherein the mobile electronic device comprises a mobile phone,
wherein recording and outputting externally, by the mobile electronic device, the first information comprises: displaying the first information on a display screen of the mobile phone and/or playing the first information through a speaker or earphones of the mobile phone.

6. The method according to claim 1, further comprising:
in the case that the communication connection is established between the electric utility vehicle and the mobile electronic device,
sending, by the mobile electronic device, a request for acquiring a device ID to the electric utility vehicle;
upon receiving the request, sending, by the electric utility vehicle, the device ID to the mobile electronic device;
connecting the mobile electronic device to an Internet and searching a cloud server for a determination of whether the device ID has usage permission;
in response to a determination that the mobile electronic device has the usage permission, enabling the electric utility vehicle to execute the operational command received from the mobile electronic device, and uploading, by the mobile electronic device, the first information and/or the second information to the cloud server; and
in response to a determination that the mobile electronic device does not have the usage permission, prohibiting the electric utility vehicle from executing the operational command received from the mobile electronic device.

7. An electric utility vehicle, comprising a memory and a processor; wherein the memory stores computer instructions; the processor is connected to the memory and configured to obtain and execute the computer instructions in the memory to implement the method according to claim 1.

8. A computer-readable medium, comprising non-volatile program code executable by a processor, wherein the program code is executed by the processor to implement the method according to claim 1.

9. An electric utility vehicle, comprising: a control system; wherein the control system comprises an operational status information acquisition unit, an information transmission unit, and an operational control unit;
the operational status information acquisition unit is configured to obtain operational status information of the electric utility vehicle;
the information transmission unit is configured to transmit the operational status information outward via wireless communication and to receive operational command information for the electric utility vehicle from a mobile electronic device;
the operational control unit is configured to control an execution component of the electric utility vehicle to perform a corresponding operation according to the received operational command information;
the operational command information is generated by the following selectable manners:
the operational command information is generated by the mobile electronic device, which is connected to the electric utility vehicle via the wireless communication, after parsing the operational status information of the electric utility vehicle, and/or
a user's operational command information for the electric utility vehicle is received by the mobile electronic device via an operation interface provided by the mobile electronic device.

10. The electric utility vehicle according to claim 9, wherein the operational status information of the electric utility vehicle comprises at least one of the followings:
work gear information;
real-time workload information of the electric utility vehicle;
travel speed information of the electric utility vehicle;
overall battery level information of the electric utility vehicle;
presence information of each of a plurality of the battery packs of the electric utility vehicle and battery level information of each battery pack;
operating time information of the electric utility vehicle;
usage time and replacement reminder information for working components of the electric utility vehicle; and
fault, brand, and ID information of the electric utility vehicle.

11. The electric utility vehicle according to claim 10, wherein the operational status information of the electric utility vehicle is acquired by the operational status information acquisition unit through one of the followings:
sensors disposed on the electric utility vehicle;
monitoring motor parameters of the electric utility vehicle; and
reading information stored in a memory of a control unit of the electric utility vehicle.

12. The electric utility vehicle according to claim 9, wherein:
the mobile electronic device comprises a first communication module,
the electric utility vehicle comprises a second communication module,
the second communication module is connected to the first communication module built in the mobile electronic device via wireless communication; and
the mobile electronic device has a built-in first application program for interacting with the electric utility vehicle.

13. The electric utility vehicle according to claim 9, wherein:
the mobile electronic device has an operation interface for receiving user operation information,
an operational information command for the electric utility vehicle is sent upon a user triggering the operation interface, and
the operation interface comprises at least one of the followings:
electronic or physical buttons;
a handle;
an operating interface;
a speaker for voice interaction; and
a visual sensor.

14. The electric utility vehicle according to claim 9, wherein the electric utility vehicle comprises an operation assembly for controlling motor operation and/or a work gear, and
in a case that a user operates the electric utility vehicle through the operation assembly, real-time status information of the electric utility vehicle is transmitted to the mobile electronic device via wireless communication.

15. The electric utility vehicle according to claim 10, wherein:
the electric utility vehicle has an automatic operation mode, and a suitable gear value and/or motor rotational speed value of the electric utility vehicle is determined based on the real-time workload information;
the mobile electronic device is configured to:
after parsing the received operational status information of the electric utility vehicle, generate a matching gear value and/or motor rotational speed value, and
transmit operational command information comprising the gear value and/or motor rotational speed value to the control system of the electric utility vehicle via wireless communication.

16. The electric utility vehicle according to claim 9, wherein the mobile electronic device has a display interface configured to display the received operational status information of the electric utility vehicle.

17. The electric utility vehicle according to claim 10, wherein the wireless communication is implemented by one of the followings:
Bluetooth communication technology;
WLAN wireless local area network communication technology;
Zigbee wireless communication technology;
UWB ultra-wideband wireless communication technology;
NFC near-field communication technology;
EnOcean communication technology; and
Z-Wave communication technology.

18. A system for controlling an electric utility vehicle, comprising:
an electric utility vehicle, comprising a work motor and a travel motor;
an operational status information acquisition unit, configured to detect load information of the work motor;
an information storage unit, configured to store data of the load information;
an information transmission unit, configured to transmit the data of the load information outward and to receive operational command information inputted from outside;
an operational control unit, configured to be in data communication with at least one of the operational status information acquisition unit, the information storage unit, or the information transmission unit;
a mobile electronic device, capable of receiving data transmitted by the information transmission unit via a wireless data connection; or capable of transmitting commands to the information transmission unit,
wherein each of the mobile electronic device and the operational control unit generates data transmitted via wireless transmission, and a gear related to the work motor is set by the mobile electronic device based on the wirelessly transmitted data;
wherein the mobile electronic device has at least one display interface, the at least one display interface is configured to prompt whether the work gear is to be adjusted and/or a suggested adjusted work gear when the information transmission unit sends information about the load to the mobile electronic device;
the mobile electronic device has at least one operation interface; when the display interface prompts the user whether the work gear is to be adjusted, the user is capable of making a selection via the operation interface, and the mobile electronic device is configured to transmit operational command information generated based on the user's selection to the operational control unit;
the mobile electronic device is configured to, after parsing the received load information, generate information about whether to adjust the work gear and/or a suggested adjusted work gear;

19. The system for controlling an electric utility vehicle according to claim 18, wherein the mobile electronic device is configured to, after parsing the received load information, generate operational command information regarding gear adjustment of the work motor, and transmit the operational command information generated by the mobile electronic device to the operational control unit; and the operational control unit is configured to control the work gear of the work motor according to the received operational command information.

20. An electric utility vehicle configured to execute the method according to claim 1.
